(19) United States
(12) Patent Application Publication
(10) Pub. No.: US 2017/0006148 A1
(43) Pub. Date: Jan. 5, 2017

(54) UNMANNED AERIAL VEHICLE AND CONTROL DEVICE THEREOF

(71) Applicant: ZEROTECH (Shenzhen) Intelligence Robot Co., Ltd., Shenzhen (CN)

(72) Inventor: Guodong Zhao, Beijing (CN)

(21) Appl. No.: 15/193,127

(22) Filed: Jun. 27, 2016

(30) Foreign Application Priority Data
Jun. 30, 2015 (CN) 201520460781.2

(51) Int. Cl. H04M 1/725; H04B 7/185

(52) U.S. Cl. CPC H04M 1/72533; H04B 7/18506

(57) ABSTRACT

A UAV control device includes: a control circuit board; a navigation module disposed on the control circuit board; a wireless communication module disposed on the control circuit board and coupled to the navigation module; a first antenna connection module disposed on the control circuit board and coupled to the wireless communication module, wherein the first antenna connection module is configured to connect with a first antenna; a positioning module disposed on the control circuit board and coupled to the navigation module; a second antenna connection module disposed on the control circuit board and coupled to the positioning module, wherein the second antenna connection module is configured to connect with a second antenna; a set of rotor driving modules and one or more camera connection modules disposed on the control circuit board and coupled to the navigation module.

### CROSS REFERENCE TO RELATED APPLICATIONS

This application claims priority to Chinese Patent Application No. 201520460781.2 filed on Jun. 30, 2015, the entire content of which is incorporated herein by reference.

### TECHNICAL FIELD

The present application relates to unmanned aerial vehicle (UAV) technology, and more particularly to a UAV and a UAV control device.

### BACKGROUND

An unmanned aerial vehicle (UAV), also referred to as an unmanned drone or drone, is an aircraft that does not carry a human operator and is remotely piloted by a remote terminal operated by an operator on the ground. In order for controlled flight of the UAV, for example, by a remote terminal, various types of components are desired to be carried on the UAV, which significantly increases the size and weight of the UAV.

Thus, there is a need for further improvement of the UAV.

### SUMMARY

An objective of the present application is to provide an UAV control device which is compact in structure.

In an aspect of the present application, there is disclosed a UAV control device. The UAV control device includes: a control circuit board; a navigation module disposed on the control circuit board; a wireless communication module disposed on the control circuit board and coupled to the navigation module; a first antenna connection module disposed on the control circuit board and coupled to the wireless communication module, wherein the first antenna connection module is configured to connect with a first antenna; a positioning module disposed on the control circuit board and coupled to the navigation module; a second antenna connection module disposed on the control circuit board and coupled to the positioning module, wherein the second antenna connection module is configured to connect with a second antenna; a set of rotor driving modules disposed on the control circuit board and coupled to the navigation module, wherein the set of rotor driving modules are configured to drive a set of rotors respectively under the control of the navigation module; and one or more camera connection modules disposed on the control circuit board and coupled to the navigation module, wherein the one or more camera connection modules are configured to connect with one or more cameras.

In another aspect of the present application, there is disclosed a UAV. The UAV includes: a body; one or more cameras attached to the body; and a control circuit board disposed within the body, wherein the control circuit board has a central region and a peripheral region outside the central region, and the control circuit board comprises: a navigation module disposed in the central region; a wireless communication module disposed in the peripheral region and coupled to the navigation module; a first antenna connection module disposed in the peripheral region and coupled to the wireless communication module, wherein the first antenna connection module is configured to connect with a first antenna; a positioning module disposed in the peripheral region and coupled to the navigation module; a second antenna connection module disposed in the peripheral region and coupled to the positioning module, wherein the second antenna connection module is configured to connect with a second antenna; a set of rotor driving modules disposed in the peripheral region and coupled to the navigation module, wherein the set of rotor driving modules are configured to drive a set of rotors respectively under the control of the navigation module; one or more camera connection modules disposed in the peripheral region and coupled to the navigation module, wherein the one or more camera connection modules are configured to connect with the one or more cameras; an inertial measurement module disposed in the central region and coupled to the navigation module; and a magnetic measurement module disposed in the peripheral region and coupled to the navigation module.

The foregoing has outlined, rather broadly, features of the present application. Additional features of the present application will be described, hereinafter, which form the subject of the claims of the present application. It should be appreciated by those skilled in the art that the conception and specific embodiments disclosed herein may be readily utilized as a basis for modifying or designing other structures or processes for carrying out the objectives of the present application. It should also be realized by those skilled in the art that such equivalent constructions do not depart from the spirit and scope of the present application as set forth in the appended claims.

### BRIEF DESCRIPTION OF THE DRAWINGS

The aforementioned features and other features of the present application will be further described in the following paragraphs by referring to the accompanying drawings and the appended claims. It will be understood that, these accompanying drawings merely illustrate certain embodiments in accordance with the present application and should not be considered as limitation to the scope of the present application. Unless otherwise specified, the accompanying drawings need not be proportional, and similar reference characters generally denote similar elements.

FIG. 1 shows an exemplary UAV system 100 according to an embodiment of the present application.

FIG. 2 shows a UAV control device 200 according to an embodiment of the present application.

FIG. 3 shows a UAV control device 300 according to an embodiment of the present application.

### DETAILED DESCRIPTION OF THE PREFERRED EMBODIMENTS

The following detailed description refers to the accompanying drawings as a part of the present application. Unless otherwise stated in the context, similar symbols generally represent similar components in the accompanying figures. The illustrative embodiments described in the detailed description, the accompanying drawings and the claims are not limiting, and other embodiments may be adopted, or modifications may be made without deviating from the spirit and subject of the present application. It should be understood that, the various aspects of the present application described and graphically presented herein may be arranged, replaced, combined, divided and designed in many different configurations, and these different configurations are implicitly included in the present application.

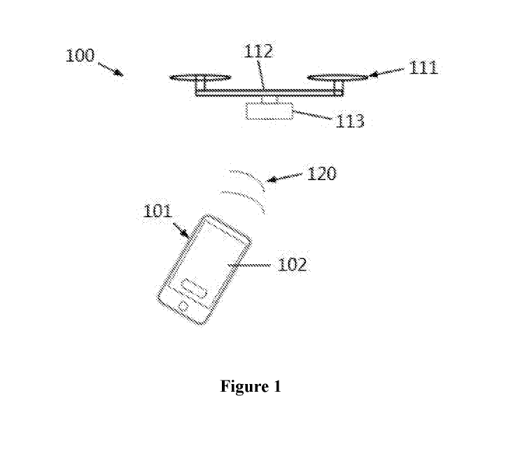

FIG. 1 shows an exemplary UAV system 100 according to an embodiment of the present application.

As shown in FIG. 1, the UAV system includes a UAV 111 having a body 112. The body 112 carries thereon a payload 113 such as a camera or the like. The UAV 111 can fly as desired by an operator or a user of the UAV system 100, and capture images such as video images during its flight in the air.

The UAV system 100 further includes a remote terminal 101. The remote terminal 101 can transmit various control instructions to the UAV 111 via a wireless communication 120, responsive to user inputs entered by the operator. Accordingly, the UAV 111 can receive the control instructions from the remote terminal 101, and respond to the control instructions to fly, capture images or implement other types of operations. The remote terminal 101 has a touch screen 102 which presents a graphic user interface (GUI) for presenting various information to the operator, such as flight-related information and video image captured by the camera on the UAV 111. The touch screen 102 may be a touch screen which is capable of detecting user's touch actions on a specific region of the touch screen.

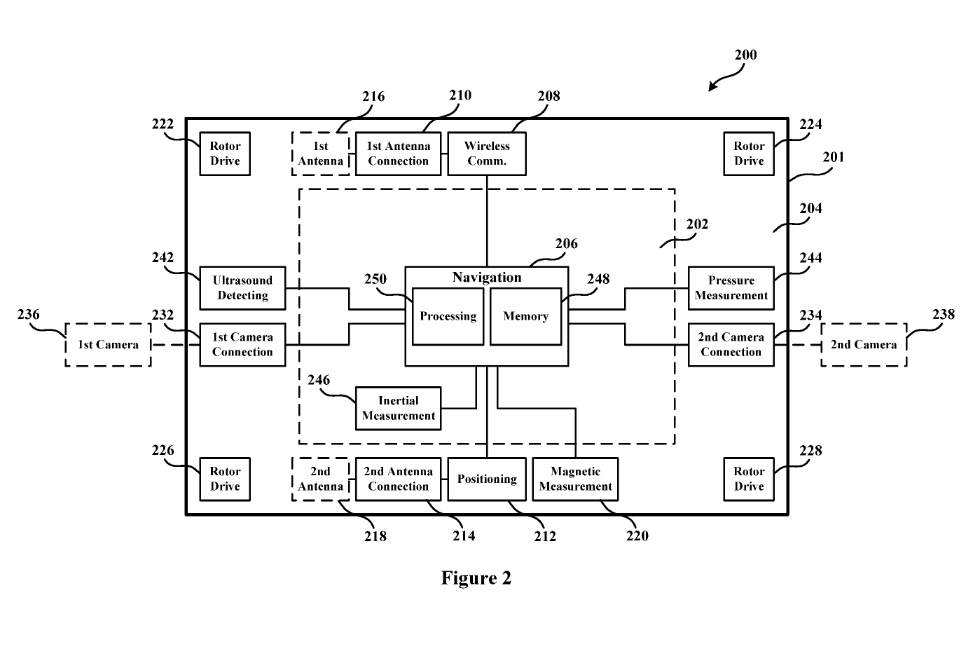

FIG. 2 shows a UAV control device 200 according to an embodiment of the present application.

The UAV control device 200 can be disposed on the UAV 111 shown in FIG. 1, for example, within the body 112 of the UAV 111. The UAV control device 200 is used to process various types signal, data and instructions for the UAV, so as to control the operation of the UAV, for example, flight of the UAV and image capturing of the camera(s) attached to the UAV

As shown in FIG. 2, the UAV control device 200 includes a control circuit board 201 where various types of circuit components of the UAV are mounted. The control circuit board 201 may be a printed circuit board (PCB) which is single sided, double sided or multi-layer such as four-layer or six-layer. The more layers the PCB contains, the higher its component density is.

Specifically, the control circuit board 201 includes a navigation module 206 disposed thereon. The navigation module 206 functions as a central control and processing unit for the electronic system of the UAV. In some embodiments, the navigation module 206 may include a processing unit 250 and a memory unit 248 coupled to the processing unit 250. The memory unit 248 may receive and store various types of data under the control of a memory controller (not shown), which may be coupled to the processing unit 250. The memory unit 248 may be a non-transitory storage medium, e.g. a Random Access Memory (RAM), a Read Only Memory (ROM), a Programmable ROM (PROM), an Erasable PROM (EPROM) or an Electric EPROM (EEPROM). The processing unit 250 may be an integrated circuit (IC) chip with signal and data processing functionality. The processing unit 250 may be a general-purpose processor such as a Central Processing Unit (CPU) or a network processor, or dedicated logics such as a Digital Signal Processing (DSP) logics, an Application Specific IC (ASIC), a Field Programmable Gate Array (FPGA) or the like.

The navigation module 206 can be used to control the flight of the UAV, e.g. performing navigation instructions to navigate the UAV to fly following a specific navigation path, object-avoiding instructions to prevent the UAV from flying into objects in the air, or specific flight instructions such as taking-off instruction, landing instruction, hovering instruction, etc. In some embodiments, the navigation module 206 may also collect sensor data from various types of sensors, e.g. pressure sensor, ultrasound sensor, inertial sensor or the like, and transmit such sensor data to a remote terminal or generate corresponding control instructions using such sensor data.

In some embodiments, the navigation module 206 may further process other types of data and instructions for target tracking, image capturing and processing, and etc. Such functionality may be implemented with hardware or software elements integrated within the navigation module 206. In some examples, the navigation module 206 may include an optical flow detecting unit for detecting an optical flow in a video captured by the UAV camera(s). The navigation 206 may further measure a speed of the UAV using the detected optical flow. In some embodiments, the navigation module 206 may include a video stabilization unit for stabilizing the video captured by the UAV camera(s). In some examples, the navigation module 206 may include a video recording unit for controlling the capturing of videos by the UAV cameras. In some examples, the navigation module 206 may include a target tracking unit for controlling the UAV to track a specific target by analyzing the videos captured by the UAV camera(s). These functional units may be integrated within the processing unit 250 or be formed as separate units in the navigation module 206.

Still referring to FIG. 2, the control circuit board 201 further includes a wireless communication module 208 disposed thereon and coupled to the navigation module 206. The wireless communication module 208 is used for wireless communication between the navigation module 206 and the remote terminal (e.g. the remote terminal 101 shown in FIG. 1), through a first antenna 216.

In the embodiment shown in FIG. 2, the first antenna 216 is disposed on the control circuit board 201, and coupled to the wireless communication module 208 via a first antenna connection module 210. In some other embodiments, however, the first antenna 216 may be formed as a separate component not disposed on the control circuit board 201. For example, the first antenna 216 may be electrically coupled to the first antenna connection module 210 on the control circuit board 201 through a connection wire or cable. Preferably, the wireless communication module 208 may be disposed adjacent with the first antenna connection module 210, e.g. 0.1 to 1 cm distant from each other, to shorten the length of a connection wire or cable therebetween and reduce the signal loss on the connection wire or cable.

The control circuit board 201 further includes a positioning module 212 disposed thereon. The positioning module 212 may be coupled to the navigation module 206, to position the UAV and transmit the positioning result to the navigation module 206. The positioning module 212 may be a Global Positioning System (GPS) device or similar devices that communicate with a positioning satellite for positioning the UAV. Alternatively, the positioning module 212 may be a radio-frequency (RF) positioning device that communicates with a remote ground device for positioning the UAV. In order for positioning signal transmission, the control circuit board 201 further includes a second antenna 218 coupled to the positioning module 212 through a second antenna connection module 214. Similar to the first antenna 216, the second antenna 214 may be either disposed on the control circuit board 201 or formed as a separate component. Preferably, the positioning module 212 may be disposed adjacent with the second antenna connection module 214, e.g. 0.1 to 1 cm distant from each other, to shorten the length of a connection wire or cable therebetween and reduce the signal loss on the connection wire or cable.

The control circuit board 201 further includes a set of rotor driving modules disposed thereon and coupled to the navigation module 206. The set of rotor driving modules drive a set of rotors respectively under the control of the navigation module 206. In the embodiment shown in FIG. 2, the set of rotor driving modules includes four rotor driving modules 222, 224, 226 and 228, being arranged at four corners of the rectangular control circuit board 201 respectively, as the UAV may be a four-disc UAV.

The control circuit board 201 further includes one or more camera connection modules disposed thereon, which include a first camera connection module 232 and a second camera connection module 234 in the embodiment shown in FIG. 2.

Through the camera connection modules 232 and 234, a first camera 236 and a second camera 238 can be coupled to the navigation module 206 to transmit the captured image, video and stream to the navigation module 206 for further processing. For example, as shown in FIG. 2, the first camera 236 and the second camera 238 are arranged outside of the control circuit board 201. The first camera 236 may be used to capture videos which can be stored in the memory 248, while the second camera 238 may be used to capture videos for object tracking and/or optical flow detecting. Accordingly, the first camera 236 may have a better resolution than the second camera 238. The cameras 236 and 238 may be carried on the payload 113 shown in FIG. 1.

It can be seen that all or at least a substantial portion of the circuit components of the UAV can be mounted on the control circuit board 201, which makes the UAV compact in structure. Thus, the integration level of the UAV can be improved, and the size and weight of the UAV can be reduced. A light-weighted UAV may have better flight durability.

The higher integration level significantly reduces the size of the control circuit board 201. In some embodiments, the control circuit board 201 may be built with a size of less than 10 cm*15 cm, e.g. 6 cm*10 cm. The compactly arranged circuit components in such a single circuit board may lead to electromagnetic compatibility issues. In some embodiments, by appropriately arranging the positions of the circuit components, this problem can be successfully resolved.

Specifically, the control circuit board 201 may have a central region 202 and a peripheral region 204 outside the central region 202.

In some examples, the central region 202 may be close to a center of the control circuit board 201 and take up at most 20% to 80% (e.g. 20%, 30%, 40%, 50%, 60%, 70% or 80%) of the area of the control circuit board 201. In some examples, the central regions 202 may have a minimal width that is 20% to 90% (e.g. 20%, 30%, 40%, 50%, 60%, 70%, 80% or 90%) of a width of the control circuit board 201. In some examples, the central region 202 may have a width of 1 cm to 15 cm, and preferably 1 cm to 5 cm. The peripheral region 204 may have a width of 1 cm to 7 cm, and preferably 1 cm to 3 cm.

The various circuit components of the control circuit board 201 may be arranged at different positions depending on their coupling relationships with the navigation module 206. In some embodiments, the navigation module 206 is disposed in the central region 202, because most of the circuit components are desired to be coupled with the navigation module 206. In this way, less wires or cables are needed to couple the navigation module 206 with the other circuit components. Moreover, in some other embodiments, an inertial measurement module 246 is also disposed in the central region 202 and coupled to the navigation module 206. The inertial measurement module 246 disposed in the central region 202 can more accurately detect a motion status of the UAV as it is generally much closer to respective mass center(s) of the control circuit board 201 and the UAV carrying the control circuit board 201. The inertial measurement module 246 may be an accelerometer, a gyroscope or the like.

Some other circuit components, such as the wireless communication module 208, the first antenna connection module 210, the positioning module 212 and the second antenna module 214, can be positioned in the peripheral region 204.

In some preferred embodiments, the first antenna connection module 210 and the second antenna connection module 214 are disposed at two opposite sides of the control circuit board 201, to reduce the interference between their respective wireless signals.

Furthermore, the rotor driving modules 222 to 228 may be disposed at respective corners of the control circuit board 201 in the peripheral regions 204. In this way, the rotor driving modules 222 to 228 can be farther away from the center of the control circuit board 201 as well as from each other, to reduce the influence of their analog signals on the navigation module 206 and some other circuit components in or near the central region 202. Moreover, connection wires or cables between the rotor driving modules 222 to 228 and respective rotors (not show) can be shorter under such arrangements.

Furthermore, the camera connection modules 232 and 234 may be disposed in the peripheral region 204 to shorten connection wires and/or cable to the respective cameras 236 and 238. Preferably, the first camera connection module 232 and the second camera connection module 234 may be disposed at two opposite sides of the control circuit board 201. As is shown in FIG. 2, the first antenna connection module 210 and the wireless communication module 208 are disposed at a first side of the control circuit board 201, the first camera connection module 232 is disposed at a second side, the second antenna connection module 214 and the positioning module 212 are disposed at a third side opposite to the first side, and the second camera connection module 232 is disposed at a fourth side opposite to the second side.

In some embodiments, the control circuit board 201 may further include a magnetic measurement module 220 which detects a magnetic field surrounding the UAV, especially a terrestrial magnetic field surrounding the UAV. The magnetic measurement module 220 is coupled to the navigation module 206 to transmit the detected magnetic field to the navigation module 206 for further processing, for example, for determination of an orientation and/or attitude of the UAV. The magnetic measurement module 220 is sensitive to the change of its surrounding magnetic field, and thus the magnetic measurement module 220 may be disposed away from the first and second antenna connection modules 210 and 214 to reduce the influence of the antennas 216 and 218 on the magnetic measurement module 220. In some preferred embodiments, the magnetic measurement module 220 and the first antenna connection module 210 may be disposed at two opposite sides of the control circuit board 201, as data traffic or throughput (or power consumption) through the first antenna 216 is heavier compared with that through the second antenna 218. In other words, where the first antenna 216 and the second antenna 218 have different data throughputs, the electromagnetic-sensitive or magnetic-sensitive components (e.g. the magnetic measurement module 220) may be positioned close to one of the antennas 216 and 218 (i.e. the respective antenna connection modules 210 and 214) having a lower data throughput.

In some embodiments, the control circuit board 201 further includes a pressure measurement module 244 and an ultrasound detecting module 242, which are disposed on the control circuit board 201 and coupled to the navigation module 206. Preferably, the pressure measurement module 244 and the ultrasound detecting module 242 may be disposed in the peripheral region 204. In some embodiments, the ultrasound detecting module 242 can detect an ultrasound wave from an external ultrasound transmitter and/or transmit an ultrasound wave out. The ultrasound detection result generated from the ultrasound detecting module 242 can be transmitted to the navigation module 206, which further determines how to avoid object(s) during the flight of the UAV based on the ultrasound detection result.

For purpose of clarification, although the UAV control device 200 are shown in FIG. 2 with its circuit components placed in specific positions of the control circuit board 201, people skilled in the art would readily appreciate various alternatives or modifications to the layout and structure of the UAV control device 200. For example, the size and/or spacing of the circuit components can be adjusted according to the size of the UAV incorporating the UAV control device 200.

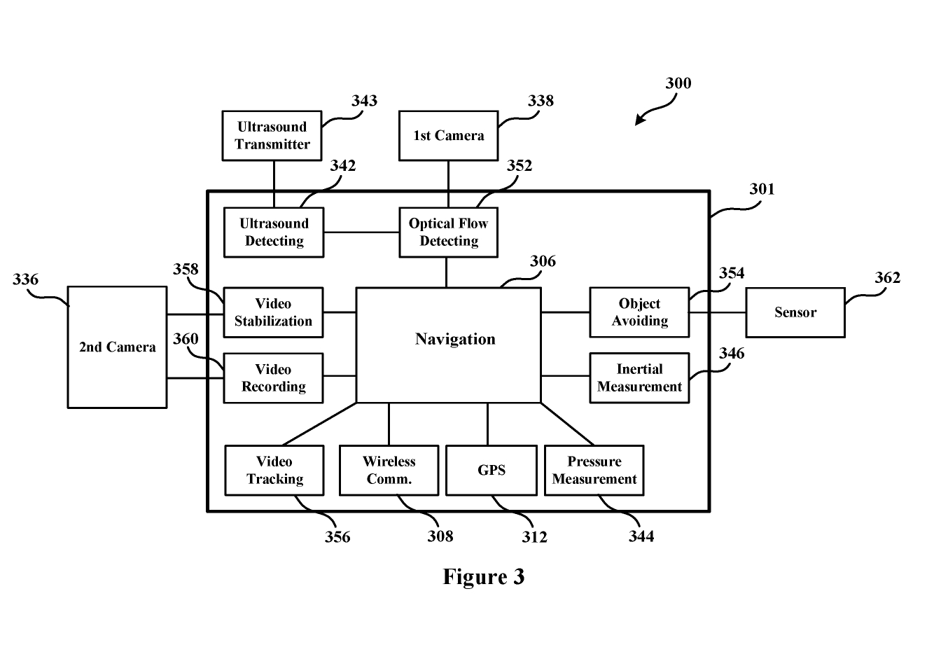

FIG. 3 shows a UAV control device 300 according to an embodiment of the present application.

As shown in FIG. 3, the UAV control device 300 include a control circuit board 301 where a navigation module 306, a wireless communication module 308, a GPS module 312, an ultrasound detecting module 342, a pressure measurement module 344, an inertial measurement module 346, an optical flow detecting module 352, an object avoiding module 354, a video tracking module 356, a video stabilization module 358, a video recording module 360 and one or more rotor control modules (not shown) are integrated. The UAV control device 300 further includes an ultrasound transmitter 343, a first camera 338, a second camera 336 and one or more rotor driving modules (not shown).

The GPS module 312, the pressure measurement module 344, and the inertial measurement module 346 all transmit their respective output signals to the navigation module 306, and the wireless communication module 308 is coupled to the navigation module 306 for two-way communication.

The ultrasound detecting module 342 is coupled to the ultrasound transmitter 343 for two-way communication. The height of the UAV in the air can be detected through the ultrasound transmitter 343.

The optical flow detecting module 352 is coupled to the ultrasound detecting module 342 and the navigation module 306, enabling two-way communication with both the two modules 342 and 306. The optical flow detecting module 352 is further coupled to the first camera 338 for two-way communication. The optical flow detecting module 352 measures the speed of the UAV using data transmitted from the first camera 338 and the ultrasound detecting module 342.

The video stabilization module 358 is coupled to the navigation module 306 for two-way communication, and coupled to the second camera 336 to improve the degree of stability of the video captured by the second camera 336.

The video tracking module 356 is coupled to the navigation module 306 for two-way communication, and used for processing video data.

The one or more rotor control modules are coupled to the navigation module 306 for two-way communication, and further coupled to the rotor driving modules for two-way communication. The rotor driving modules are coupled to one or more rotors, respectively. The rotor control modules are used to control the operation of the rotors, e.g. the rotation speed of the rotors.

The object avoiding module 354 is coupled to the navigation module 306 for two-way communication, and coupled to one or more sensors 362 for two-way communication. The object avoiding module 354 and the sensors 362 are used to detect objects surrounding the UAV.

After the UAV takes off from the ground, the navigation module 306 may transmit an instruction to activate all or a portion of the modules on the control circuit board 301. The inertial measurement module 346 transmits an angular speed signal and an acceleration signal to the navigation module 306. The GPS module 312 and the pressure measurement module 344 transmit vertical and horizontal position information of the UAV to the navigation module 306, respectively. The wireless communication module 308 transmits ground information to the navigation module 306, and transmits flight information of the UAV from the navigation module 306 to a remote terminal on the ground. The video stabilization module 358 is used to stabilize the camera(s) (e.g. the second camera 336) in real-time according to measurement results of the inertial measurement module 346, the GPS module 312, the pressure measurement module 344 and the optical flow detecting module 352. For example, the video stabilization module 358 can be used to stabilize angles for rotating the camera(s) horizontally or vertically. The object avoiding module 354 can detect the objects surrounding the UAV when the UAV flies in the air, and transmit object-related data to the navigation module 306. When it is desired to change the flight path to avoid the objects, the navigation module 306 may plan a new flight path, and the video stabilization module 358 can adjust the angle of the camera 336 to improve the degree of stability.

Moreover, the navigation module 306 may transmit target data of a target to the video recording module 360, and correspondingly, the video recording module 360 may adjust the angle of the camera to keep aiming at the target. If an angle of the target exceeds the angle of the camera, feedback information may be transmitted to the navigation module 306. The navigation module 306 may then generate flight instructions of controlling the operation of the rotors, to move the UAV to a position substantially on top of the target, thereby aiming at the target again. After aiming at the target, the video recording module 360 may control the video capturing of the camera 336 and store the captured video data into a memory.

The video tracking module 356 reads from the memory the target data, analyzes and extracts characteristic information and position information of the target, and transmits the position information to the video recording module 360 through the navigation module 306, so that the video recording module 360 may control the angle of the camera in real-time to keep aiming at the target during the video capturing.

It should be noted that the functions and coupling relationships of the circuit components of the UAV control device 300 are described with reference to the embodiment shown in FIG. 3, such description is exemplary only and not intended to limit the scope of the application. Particularly, it is not required to place the circuit components in a manner the same as that shown in FIG. 3, since FIG. 3 only illustrates an exemplary block diagram of the UAV control device, rather than a physical layout thereof including specific positions of the circuit components in the control circuit board. In practice, all or a portion of the circuit components of the UAV control device may be placed similar to the layout diagram shown in FIG. 2, or alternatively, be placed in any other suitable manners that allow a compact structure.

It should be also noted that, although several exemplary circuit components are described above with reference to the specific embodiments of the present application, other suitable circuit components can be integrated within the control circuit board to simplify the structure of the UAV.

Those skilled in the art may understand and implement other variations to the disclosed embodiments from a study of the drawings, the present application, and the appended claims. In the claims, the word “comprising” does not exclude other elements or steps, and the indefinite article “a” or “an” does not exclude a plurality. In applications according to present application, one element may perform functions of several technical feature recited in claims. Any reference signs in the claims should not be construed as limiting the scope. The scope and spirit of the present application is defined by the appended claims.

What is claimed is:

1. An unmanned aerial vehicle (UAV) control device, comprising:
a control circuit board;
a navigation module disposed on the control circuit board;
a wireless communication module disposed on the control circuit board and coupled to the navigation module;
a first antenna connection module disposed on the control circuit board and coupled to the wireless communication module, wherein the first antenna connection module is configured to connect with a first antenna;
a positioning module disposed on the control circuit board and coupled to the navigation module;
a second antenna connection module disposed on the control circuit board and coupled to the positioning module, wherein the second antenna connection module is configured to connect with a second antenna;
a set of rotor driving modules disposed on the control circuit board and coupled to the navigation module, wherein the set of rotor driving modules are configured to drive a set of rotors respectively under the control of the navigation module; and
one or more camera connection modules disposed on the control circuit board and coupled to the navigation module, wherein the one or more camera connection modules are configured to connect with one or more cameras.

2. The UAV control device of claim 1, wherein the control circuit board has a central region and a peripheral region outside the central region; and wherein
the navigation module is disposed in the central region, and
the wireless communication module, the first antenna connection module, the positioning module, the second antenna connection module, the set of rotor driving module and the one or more camera connection modules are disposed in the peripheral region.

3. The UAV control device of claim 2, further comprising:
an inertial measurement module disposed in the central region and coupled to the navigation module.

4. The UAV control device of claim 2, further comprising:
a magnetic measurement module disposed in the peripheral region and coupled to the navigation module.

5. The UAV control device of claim 4, wherein the magnetic measurement module and the first antenna connection module are disposed at two opposite sides of the control circuit board.

6. The UAV control device of claim 2, wherein the first antenna connection module and the second antenna connection module are disposed at two opposite sides of the control circuit board

7. The UAV control device of claim 6, wherein the first antenna and second antenna have different data throughput.

8. The UAV control device of claim 2, wherein the one or more camera connection modules comprises a first camera connection module and a second camera connection module which are disposed at two opposite sides of the control circuit board.

9. The UAV control device of claim 1, wherein the wireless communication module is disposed adjacent with the first antenna connection module.

10. The UAV control device of claim 1, wherein the positioning module is disposed adjacent with the second antenna connection module.

11. The UAV control device of claim 1, wherein the control circuit board is of a rectangular shape, and the set of rotor driving modules are disposed at respective corners of the control circuit board.

12. The UAV control device of claim 1, wherein the navigation module comprises a processing unit and a memory unit, which is coupled to the processing unit.

13. The UAV control device of claim 1, further comprising:
a pressure measurement module disposed on the control circuit board and coupled to the navigation module.

14. The UAV control device of claim 1, further comprising:
an ultrasound detecting module disposed on the control circuit board and coupled to the navigation module.

15. A UAV comprising
a body;
one or more cameras attached to the body; and
a control circuit board disposed within the body, wherein the control circuit board has a central region and a peripheral region outside the central region, and the control circuit board comprises:
a navigation module disposed in the central region;
a wireless communication module disposed in the peripheral region and coupled to the navigation module;
a first antenna connection module disposed in the peripheral region and coupled to the wireless communication module, wherein the first antenna connection module is configured to connect with a first antenna;
a positioning module disposed in the peripheral region and coupled to the navigation module;
a second antenna connection module disposed in the peripheral region and coupled to the positioning module, wherein the second antenna connection module is configured to connect with a second antenna;
a set of rotor driving modules disposed in the peripheral region and coupled to the navigation module, wherein the set of rotor driving modules are configured to drive a set of rotors respectively under the control of the navigation module;
one or more camera connection modules disposed in the peripheral region and coupled to the navigation module, wherein the one or more camera connection modules are configured to connect with the one or more cameras;
an inertial measurement module disposed in the central region and coupled to the navigation module; and
a magnetic measurement module disposed in the peripheral region and coupled to the navigation module.

16. The UAV of claim 15, wherein the magnetic measurement module and the first antenna connection module are disposed at two opposite sides of the control circuit board.

17. The UAV of claim 15, wherein the first antenna connection module and the second antenna connection module are disposed at two opposite sides of the control circuit board.

18. The UAV of claim 17, wherein the first antenna connection module and the second antenna connection module have different data throughputs, and wherein the magnetic measurement module is disposed close to one of the first and second antenna connection modules having a lower data throughput.

19. The UAV of claim 15, wherein the one or more camera connection modules comprises a first camera connection module and a second camera connection module which are disposed at two opposite sides of the control circuit board.

20. The UAV of claim 15, wherein the wireless communication module is disposed adjacent with the first antenna connection module.

21. The UAV of claim 15, wherein the positioning module is disposed adjacent with the second antenna connection module.

22. The UAV of claim 15, wherein the control circuit board is of a rectangular shape, and the set of rotor driving modules are disposed at respective corners of the control circuit board.
